(19) United States
(12) Patent Application Publication
(10) Pub. No.: US 2023/0263108 A1
(43) Pub. Date: Aug. 24, 2023

(54) PROCESS TO GROW PLANTS IN A GREENHOUSE

(71) Applicant: Van der Hoeven Horticultural Projects B.V., Den Hoorn (NL)

(72) Inventor: Gerardus Hugo Antonius van Bergenhenegouwen, Monster (NL)

(21) Appl. No.: 18/100,631

(22) Filed: Jan. 24, 2023

(30) Foreign Application Priority Data
Jan. 25, 2022 (NL) 2030686

(51) Int. Cl. A01G 9/24

(52) U.S. Cl. CPC A01G 9/246; A01G 9/247

(57) ABSTRACT

A process to grow plants in a greenhouse includes supplying cooled air to the interior of the greenhouse and supplying irrigation water to the plants. The cooled air is obtained by directly cooling air against evaporating water in one or more cooling pads where water flows downwardly via an open structure and in which open structure the air directly contacts the evaporating water to obtain cooled air and non-evaporated water. Part of the non-evaporated water is used as irrigation water and part is reused in the one or more cooling pads.

### BACKGROUND

The invention is directed to a process to grow plants in a greenhouse by supplying cooled air to the interior of the greenhouse and by supplying irrigation water to the plants. The cooled air is obtained by directly cooling air against evaporating water in one or more cooling pads.

Such processes are well known and for example described in WO 2017/176114. In this process ambient air is cooled by directly contacting the air with liquid water wherein part of the water evaporates to obtain air with a reduced temperature. This cooled air is subsequently contacted with an aqueous hygroscopic solution and subsequently contacted with liquid water. The contacting with liquid water takes place in cooling pads.

WO2004/068051 describes cooling pads for use in cooling poultry houses where non-evaporated water is recycled to the evaporating pads via a reservoir. A control system ensures that sufficient recirculating water is in the system.

EP1659357 describes a cooling pad where non-evaporated water is collected in a water tank and recirculated from this tank to the cooling pad.

US5966953 describes a cooling pad where non-evaporated water is collected in a water tank and recirculated from this tank to the cooling pad. In its introductory part it is explained that the recirculating water will contain high amounts of minerals after a few days of operation. By dumping part of this water the level of minerals could be kept below certain acceptable ranges. A problem of such dumping is that the surrounding areas may become muddy which can be a substantial inconvenience.

### SUMMARY OF THE INVENTION

The present invention provides a process to grow plants in a greenhouse which does not have some of the identified problems of the prior art.

This is achieved by the following process:
supplying cooled air to the interior of the greenhouse and by supplying irrigation water to the plants in the interior of the greenhouse,
wherein cooled air is obtained by directly cooling air against evaporating water in one or more cooling pads where water flows downwardly via an open structure and in which open structure the air directly contacts the evaporating water to obtain cooled air and non-evaporated water, and
wherein part of the non-evaporated water is used as irrigation water and part is reused in the one or more cooling pads.

### BRIEF DESCRIPTION OF THE DRAWINGS

FIG. 1 is a cross-sectional view of a greenhouse according to an embodiment of the invention.

### DETAILED DESCRIPTION

Applicants found that by using part of the non-evaporated water as irrigation water it is possible to avoid a build-up of minerals in the circulating water. This avoids having to dispose of large volumes of high mineral streams which is the state of the art situation for many years. It has been found that the build-up of minerals in the water can be kept low, thereby making the water suitable for irrigation.

The cooling pads are typically provided with a tank in which the non-evaporated water is collected as, for example, described in the earlier referred to prior publications. This tank is typically positioned below the cooling pads and non-evaporated water flows to such a tank by means of gravity. In prior art processes a purge would be connected to such a tank for discharging a high-mineral content streams. In the present invention the collecting tanks of the cooling pads are also present. These tanks are suitably fluidly connected to a larger water reservoir such that the part of the non-evaporated water can be discharged from the tank to the larger water reservoir. From the larger water reservoir irrigation water is supplied to the plants. Preferably more than 5% of non-evaporated water is supplied to one or more water reservoirs, and even more preferably between 20 and 50% of non-evaporated water is supplied to the one or more water reservoirs.

The one or more water reservoirs preferably also have a fluid connection to a fresh water supply. Fresh water may be for example potable water, rainwater, sourced from surface and/or sub-surface reservoirs and/or non-conventional resources such as industrial treated wastewater. This water supply will provide water to compensate for the water which evaporates in the one or more cooling pads and to compensate for the water which is supplied to the plants as irrigation water.

The one or more water reservoirs are also fluidly connected to the one or more cooling pads such to provide make-up water from the one or more reservoirs to the one or more cooling pads. The make-up water compensates for at least in part for the evaporating water and for the part of the non-evaporated water which is returned to the one or more water reservoirs. In this manner the water in the one or more water reservoirs as well as the water which is recirculated over a cooling pad via the afore mentioned tank is refreshed and build-up of minerals is avoided. The presence of minerals may be expressed as the electrical conductivity (EC) of the water, wherein a high conductivity indicates a high mineral content. It has been found that the above process can provide the cooling capacity in the cooling pads as well as provide a water quality suited for irrigation, optionally after a further treatment, when the electrical conductivity (EC) of the water is below 0.1 S/m and preferably between 0.01 and 0.1 S/m.

Further it has been found that the one or more water reservoirs suitably have a minimal volume in relation to the number of cooling pads. This volume will provide a buffer for the water and maintain the quality with respect of mineral content. Preferably the volume of the total of the one or more water reservoirs is more than 0.4 m³ and more preferably more than 0.5 m³ per meter horizontal length of the one or more cooling pads. By meter horizontal length of the one or more cooling pads it is meant that when the one or more cooling pads as present would be vertically positioned as in their typical orientation and in one line, the resulting horizontal length would be the distance of this row.

A greenhouse system is here defined as a system consisting of a single space growing section in which the plants are cultivated at a controlled climate. A controlled climate is a climate wherein at least temperature and humidity in the growing section are controlled. Thus, in one greenhouse building more than one greenhouse system may be present.

The cooling pads are suitably cooling pads having a vertical liquid water flow path of between 0.5 and 3 m. By vertical liquid water flow path it is meant the vertical distance water travels as it flows downwardly via the open structure in a substantially upright or tilted cooling pad.

The volume of water in the one or more reservoirs is suitably maintained within a lower and upper limit by supplying fresh water to the one or more reservoirs.

The irrigation water as supplied to the plants may be the non-evaporated water and especially the non-evaporated water as stored in the one or more reservoirs as described above. This water may be treated before being supplied to the plants, for example, to reduce any mineral ions, bacteria, biofilms, yeasts or other microorganisms which may be present in the water. Examples of suitable treatments are UV treatment and/or thermal treatments. Other treatments which may be used alone or in combination with one of the mentioned treatments are, for example, addition or in situ generation of ozone, chlorine, hypochlorite and hydrogen peroxide; membrane filtration; electrodialysis; and ultrasonic noise treatment. An example of a suitable treatment is the addition of thermal and non-thermal plasma activated water which comprises nitrites and hydrogen peroxide compounds as described in US2018/0327283. Such a process is capable of reducing the undesired bacteria, biofilms, yeasts or other microorganisms while also providing nitrogen species which may act as a fertiliser.

The cooled air may be cooled ambient air, cooled air from within the greenhouse and/or cooled mixtures of ambient air and air from within the greenhouse. An example wherein the cooled air is only ambient air is described in WO2008/002686. Applicant has found that the following process is even more advantageous, wherein the greenhouse comprises a growing space and a separate mixing space and wherein
(a) ambient air and air from the growing space is collected and mixed in the separate mixing space to obtain a mixed feed air,
(b) obtaining the cooled air by directly contacting part of the mixed feed air against evaporating water in the one or more cooling pads and wherein another part of the feed air does not contact directly with liquid water in the one or more cooling pads to obtain bypass air, and
(c) mixing the cooled air and the bypass air to obtain a conditioned air as present in a space for conditioned air and discharging the conditioned air to the growing space.

Applicants found that this process is better able to condition the air as it is discharged to the growing space. In this process it is possible to mix ambient air and air from the growing section to obtain a mixed feed air which is subsequently cooled according to this invention. The cooled air obtained in the cooling pads will often have a too high humidity for direct use in the growing space. By mixing this high humidity air with air from the parallel air flow path an optimal conditioned air may be obtained to be discharged into the growing space. This air bypasses the water pads. In this way the excessive humidity may be reduced by the sensible heat of, for example, warm recycle air from the growing section. This results in a more energy efficient climate control. The design of the greenhouse further allows for a careful control of the humidity of the air as it is discharged to the growing space.

The conditioned air is preferably discharged to the growing space via multiple parallel positioned ventilation conduits, typically tubes or converging conduits as described in WO2019/185503. Such conduits are at one end fluidly connected to the space for conditioned air. The parallel air flow path for the other part of the feed air, which does not contact directly with liquid water, may be formed by an opening or openings between the mixing space and the space for conditioned air. This opening does not comprise of a water pad. At the upstream end, or otherwise at the inlet, of the ventilation conduits a ventilator is suitably present. By action of this ventilator the pressure in the space for conditioned air will be lower than the pressure in the mixing space resulting in a positive air flow from the mixing space via the water pads and via the parallel air flow path to the space for conditioned air. The ratio of air which flows via the cooling pads and the parallel air flow path may thus be influenced by the size of these opening or openings. The size of the openings may be influenced by means of louvres. Preferably this ratio is influenced by air displacement means as present in the bypass air flow path. By controlling these air displacement means, suitably ventilators, the flow of air which flows via the parallel air flow path may be controlled.

Further it is preferred that the parallel air flow path comprises one or more heating units. These heating units may be indirect heat exchange units. For example, a shell-tube heat exchange unit wherein a heating fluid, for example, water, flows via tubes and the air flows at the so-called shell side of the heat exchanger. The flow and/or temperature of the heating fluid are preferably controllable. In this way an optimal volume of bypass air having an optimal temperature may be obtained such to obtain a desired volume of conditioned air having a desired temperature and humidity.

In the above process the rectangular greenhouse has a roof, a floor, two end walls and two side walls, wherein the mixing space is defined by part of the roof of the greenhouse, an end wall or a side wall and a vertical partition wall spaced apart from the end wall or side wall and running substantially parallel to the end wall or side wall and the floor or a substantially horizontal and elevated partition floor spaced apart from the floor, wherein the ambient air enters the mixing space via one or more openings in the end wall or side wall and/or in the roof, and wherein the air from the growing space enters the mixing space via one or more openings in the partition wall.

The separate mixing space and the space for conditioned air are suitably a continuous space running along the end wall or side wall of a rectangular greenhouse.

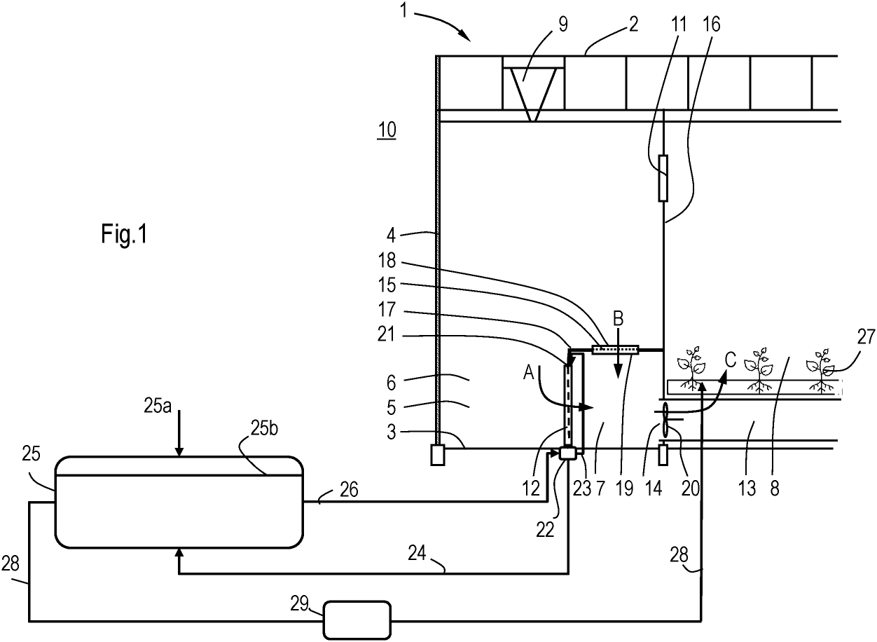

FIG. 1 shows a cross-sectional view of a greenhouse (1) having a saddle roof (2) and a floor (3). An elongated mixing space (6) is present along the entire end gable wall (4). A side wall (5) is present at the end of the elongated mixing space (6). The mixing space (6) is fluidly connected to the exterior (10) of the greenhouse by means of closable openings (9) for ambient air as present in the saddle roof (2). An elongated space (7) for conditioned air is shown positioned at the lower end of a partition wall (16). At the upper end part of this partition wall (16) one or more closable openings (11) are shown which openings (11) allow air to flow from a growing space (8). The mixing space (6) and the space (7) for conditioned air is separated from a growing space (8). The mixing space (6) and the space (7) for conditioned air are fluidly connected via one or more cooling pads (12) and via one or more indirect heating units (15) as present in a parallel air flow path (B). The air from the mixing space (6) can flow to the space for conditioned air (7) via two parallel flow paths (A) and (B) as shown. The humid air flowing in air flow path (A) and the heated air in parallel air flow path (B) are mixed in the space (7) and the resulting conditioned air is distributed in the growing section (8) via a multitude of parallel ventilation conduits (13) as schematically represented by arrow C. Conditioned air enters the ventilation conduit at an inlet (14). At this inlet (14) a ventilator (20) is present.

The mixing space (6) of FIG. 1 is bounded by part of the roof (2), the part of the side walls (5), part of the floor (3), partition wall (16) and the end wall (4). A horizontal roof part (17) is connected to the upper end (21) of the cooling pads (12). The roof part (17) is connected at its other elongated end to the partition wall (16). The roof part (17) is comprised of the one or more indirect heating units (15) having an inlet side for air (18) fluidly connected to the mixing space (6) and an outlet side for air (19) fluidly connected to the space (7) for conditioned air.

The cooling pads (12) are provided with a tank (22) in which the non-evaporated water is collected. Tank (22) is positioned below the cooling pads (12) and non-evaporated water flows to tank (22) by means of gravity. Via conduit (23) part of the water as present in the tank is supplied to the upper end (21) of the cooling pads (12). Via conduit (24) part of the water as present in tank (22) is supplied to a reservoir (25) and via stream (26) make-up water is supplied from the reservoir (25) to tank (22).

To reservoir (25) fresh water is supplied via stream (25a) and irrigation water is supplied to the plants (27) via steam (28). In stream (28) a treatment unit (29) may be present, for example a UV treatment unit. Reservoir (25) is provided with a control to maintain a water level (25b) between a minimum and maximum value.

1. A process to grow plants in a greenhouse, the process comprising:
supplying cooled air to an interior of the greenhouse and supplying irrigation water to the plants in the interior of the greenhouse,
wherein cooled air is obtained by directly cooling air against evaporating water in one or more cooling pads where water flows downwardly via an open structure and in which open structure the air directly contacts the evaporating water to obtain cooled air and non-evaporated water, and
wherein part of the non-evaporated water is used as irrigation water and part of the non-evaporated water is reused in the one or more cooling pads.

2. A process according to claim 1, wherein more than 5% of the non-evaporated water is supplied to one or more water reservoirs and irrigation water is supplied from the one or more water reservoirs to the plants.

3. A process according to claim 2, wherein between 20% and 50% of the non-evaporated water is supplied to the one or more water reservoirs.

4. A process according to claim 3, wherein make-up water is supplied from the one or more reservoirs and/or from a source of fresh water to the one or more cooling pads to compensate at least in part for the evaporating water and for the part of the non-evaporated water that is used as irrigation water.

5. A process according to claim 4, wherein the electrical conductivity (EC) of the water in the one or more water reservoirs is below 0.1 S/m.

6. A process according to claim 5, wherein the electrical conductivity (EC) of the water in the one or more water reservoirs is between 0.01 and 0.1 S/m.

7. A process according to claim 1, wherein the cooling pads have a horizontal length and a total volume of the one or more water reservoirs is more than 0.4 m³ per meter horizontal length of the one or more cooling pads.

8. A process according to claim 7, wherein the total volume of the one or more water reservoirs is more than 0.5 m³ per meter horizontal length of the one or more cooling pads.

9. A process according to claim 2, wherein a volume of water as supplied in a period of 7 days to the plants as irrigation water from the one or more water reservoirs is greater than the volume of non-evaporated water supplied to the one or more water reservoirs in the same period of days.

10. A process according to claim 2, wherein a volume of water in the one or more reservoirs is maintained within a lower and upper limit by supplying fresh water to the one or more reservoirs.

11. A process according to claim 1, wherein the irrigation water is first subjected an UV treatment, filtration, membrane filtration, and/or thermal treatment before being supplied to the plants.

12. A process according to claim 1, wherein the cooled air is cooled ambient air, cooled air from within the greenhouse, and/or cooled mixtures of ambient air and air from within the greenhouse.

13. A process according to claim 12, wherein the greenhouse comprises a growing space and a separate mixing space, and
wherein (a) ambient air and air from the growing space is collected and mixed in the separate mixing space to obtain a mixed feed air, (b) cooled air is obtained by directly contacting part of the mixed feed air against evaporating water in the one or more cooling pads and bypass air is obtained by another part of the feed air not directly contacting with liquid water in the one or more cooling pads, and (c) the cooled air and the bypass air are mixed to obtain a conditioned air and discharging the conditioned air to the growing space.

14. A process according to claim 13, wherein the mixed feed air that is not contacted directly with liquid water is increased in temperature before being mixed with the cooled air.

15. A process according to claim 13, wherein the separate mixing space is a continuous space running along an end wall or a side wall of the greenhouse, which is rectangular.

16. A process according to claim 15, wherein the rectangular greenhouse has a roof, a floor, two end walls and two side walls,
wherein the mixing space is defined by part of the roof of the greenhouse, an end wall or a side wall, and a vertical partition wall spaced apart from the end wall or side wall and running substantially parallel to the end wall or side wall and the floor or a substantially horizontal and elevated partition floor spaced apart from the floor,
wherein the ambient air enters the mixing space via one or more openings in the end wall or side wall and/or in the roof, and
wherein the air from the growing space enters the mixing space via one or more openings in the partition wall.
